(19) United States
(12) Patent Application Publication
(10) Pub. No.: US 2016/0258591 A1
(43) Pub. Date: Sep. 8, 2016

(54) LUMINESCENT VEHICLE MOLDING

(71) Applicant: Ford Global Technologies, LLC, Dearborn, MI (US)

(72) Inventors: Stuart C. Salter, White Lake, MI (US); James J. Surman, Clinton Township, MI (US); Paul Kenneth Dellock, Northville, MI (US); Dragos Maciuca, Mountain View, CA (US); Chester Stanislaus Walawender, Livonia, MI (US)

(73) Assignee: Ford Global Technologies, LLC

(21) Appl. No.: 15/006,648

(22) Filed: Jan. 26, 2016

Related U.S. Application Data
(63) Continuation-in-part of application No. 14/640,727, filed on Mar. 6, 2015.

(51) Int. Cl. F21S 8/10; H05B 37/02; B60Q 1/32

(52) U.S. Cl. CPC F21S 48/234; B60Q 1/323; F21S 48/2218; H05B 37/0227

(57) ABSTRACT

A lighting apparatus for a vehicle is disclosed. The lighting apparatus comprises a cover portion mounted to a body panel and forming an opening extending along a perimeter of the body panel. The apparatus further comprises at least one light source disposed within the opening and configured to emit light outward through the opening. A reflective portion is disposed proximate the opening. The light is projected from the reflective portion to illuminate a region proximate the vehicle.

### CROSS-REFERENCE TO RELATED APPLICATION

This application is a continuation-in-part of U.S. patent application Ser. No. 14/640,727, filed Mar. 6, 2015, and entitled “LUMINESCENT VEHICLE MOLDING,” the entire disclosure of which is hereby incorporated herein by reference.

### FIELD OF THE DISCLOSURE

The present disclosure generally relates to vehicle lighting systems, and more particularly, to vehicle lighting systems employing one or more photoluminescent structures.

### BACKGROUND OF THE DISCLOSURE

Illumination arising from the use of photoluminescent structures offers a unique and attractive viewing experience. It is therefore desired to implement such structures in automotive vehicles for various lighting applications.

### SUMMARY OF THE DISCLOSURE

According to one aspect of the present disclosure, a lighting apparatus for a vehicle is disclosed. The lighting apparatus comprises a cover portion mounted to a body panel and forming an opening extending along a perimeter of the body panel. The apparatus further comprises at least one light source disposed within the opening and configured to emit light outward through the opening. A reflective portion is disposed proximate the opening. The light is projected from the reflective portion to illuminate a region proximate the vehicle.

According to another aspect of the present disclosure, a monitoring system for a vehicle is disclosed. The monitoring system comprises a lighting apparatus having a cover portion disposed proximate a perimeter of a body panel. A light source is concealed by the cover portion and configured to output an emission. The monitoring system further comprises an imaging device configured to capture a field of view and a controller in communication with the imaging device and the light source. The controller is configured to receive image data from the imaging device and illuminate a region proximate the vehicle with the emission. The region proximate the vehicle corresponds to the field of view of the imaging device.

According to yet another aspect of the present disclosure, a molding of a vehicle is disclosed. The molding is configured to illuminate a field of view of an imaging system of the vehicle. The molding comprises a cover portion at least partially covering a seam of a body panel of the vehicle. A carrier is disposed between the cover portion and the body panel. The carrier has an exposed portion configured to luminesce in response to light excitation. The molding further comprises at least one light source configured to emit light for exciting the exposed portion.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1A illustrates a photoluminescent structure coupled to a substrate, according to one embodiment;

FIG. 1B illustrates a photoluminescent structure coupled to a substrate, according to another embodiment;

FIG. 1C illustrates a photoluminescent structure coupled to a substrate, according to yet another embodiment;

FIG. 2 is a front perspective view of a vehicle having a molding configured to luminesce;

FIG. 3 is a rear perspective view of a vehicle having molding configured to luminesce;

FIG. 4 is a cross-sectional view of a vehicle molding taken through line IV-IV of FIG. 2;

FIG. 5 is a cross-sectional view of a vehicle molding taken through line V-V of FIG. 3;

FIG. 6 illustrates a plurality of light sources disposed on a flexible circuit board that is snapably engaged to a carrier;

FIG. 7 is a top view of a monitoring system for a vehicle demonstrating a plurality of monitored fields of view; and

FIG. 8 is a block diagram of a controller configured to control a plurality of imaging devices and a light source of a molding in accordance with the disclosure.

### DETAILED DESCRIPTION OF THE PREFERRED EMBODIMENTS

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a vehicle lighting system 8 that may employ one or more photoluminescent structures configured to convert light received from an associated light source and re-emit the light at a different wavelength. The vehicle lighting system 8 may be utilized to illuminate an area proximate a vehicle. The illumination may be controlled to provide for improved lighting for one or more camera or driver assist systems of the vehicle. In this way, the lighting system 8 provides for improved imaging for the camera system in dark ambient lighting conditions.

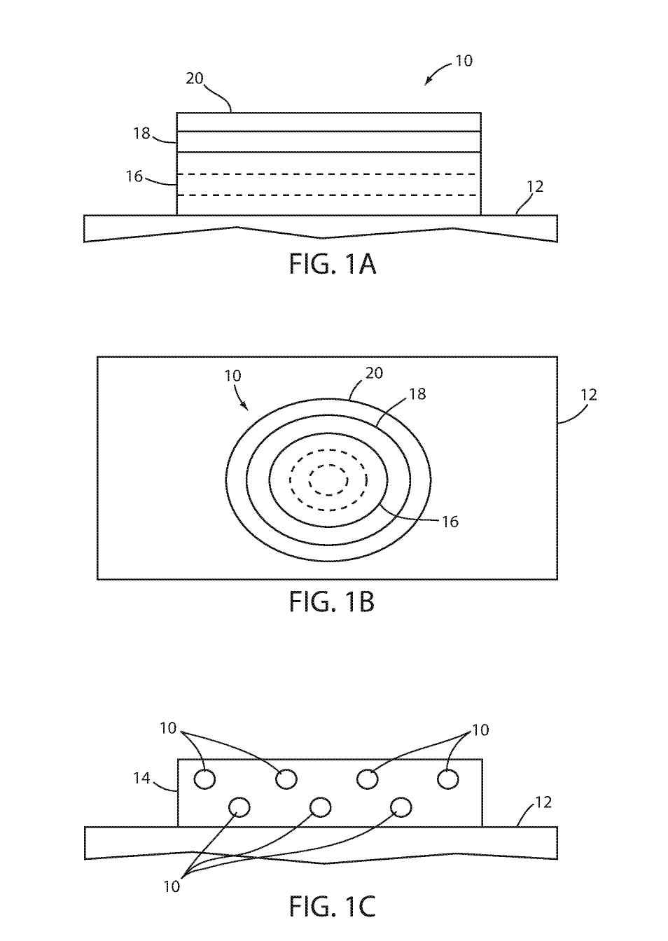

Referring to FIGS. 1A-1C, various exemplary embodiments of a photoluminescent structure 10 are shown, each capable of being coupled to a substrate 12, which may correspond to a vehicle fixture or vehicle related piece of equipment. In FIG. 1A, the photoluminescent structure 10 is generally shown rendered as a coating (e.g. a film) that may be applied to a surface of the substrate 12. In FIG. 1B, the photoluminescent structure 10 is generally shown as a discrete particle capable of being integrated with a substrate 12. In FIG. 1C, the photoluminescent structure 10 is generally shown as a plurality of discrete particles that may be incorporated into a support medium 14 (e.g. a film) that may then be applied (as shown) or integrated with the substrate 12.

At the most basic level, a given photoluminescent structure 10 includes an energy conversion layer 16 that may include one or more sub layers, which are exemplarily shown through broken lines in FIGS. 1A and 1B. Each sub layer of the energy conversion layer 16 may include one or more photoluminescent materials having energy converting elements with phosphorescent or fluorescent properties. Each photoluminescent material may become excited upon receiving light of a specific wavelength, thereby causing the light to undergo a conversion process. Under the principle of down conversion, the inputted light is converted into a longer wavelength light that is outputted from the photoluminescent structure 10. Conversely, under the principle of up conversion, the inputted light is converted into a shorter wavelength light that is outputted from the photoluminescent structure 10. When multiple distinct wavelengths of light are outputted from the photoluminescent structure 10 at the same time, the wavelengths of light may mix together and be expressed as a multicolor light.

In some embodiments, light that has been down converted or up converted may be used to excite other photoluminescent material(s) found in the energy conversion layer 16. The conversion process may include using converted light outputted from one photoluminescent material to excite another, and so on, may be referred to as an energy cascade and may serve as an alternative for achieving various color expressions. With respect to either conversion principle, the difference in wavelength between the exciting light and the converted light is known as the Stokes shift and serves as the principle driving mechanism for an energy conversion process corresponding to a change in wavelength of light. In the various implementations discussed herein, each of the photoluminescent structures may operate under either conversion principle.

The energy conversion layer 16 may be prepared by dispersing the photoluminescent material in a polymer matrix to form a homogenous mixture using a variety of methods. Such methods may include preparing the energy conversion layer 16 from a formulation in a liquid carrier medium and coating the energy conversion layer 16 to a desired substrate. The energy conversion layer 16 may be applied to a substrate by painting, screen printing, spraying, slot coating, dip coating, roller coating, and bar coating. Alternatively, the energy conversion layer 16 may be prepared by methods that do not use a liquid carrier medium. For example, the energy conversion layer 16 may be rendered by dispersing the photoluminescent material into a solid state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate using any methods known to those skilled in the art. When the energy conversion layer 16 includes sub layers, each sub layer may be sequentially coated to form the energy conversion layer 16. Alternatively, the sub layers can be separately prepared and later laminated or embossed together to form the energy conversion layer 16. Alternatively still, the energy conversion layer 16 may be formed by coextruding the sub layers.

Referring back to FIGS. 1A and 1B, the photoluminescent structure 10 may optionally include at least one stability layer 18 to protect the photoluminescent material contained within the energy conversion layer 16 from photolytic and thermal degradation. The stability layer 18 may be configured as a separate layer optically coupled and adhered to the energy conversion layer 16. Alternatively, the stability layer 18 may be integrated with the energy conversion layer 16. The photoluminescent structure 10 may also optionally include a protective layer 20 optically coupled and adhered to the stability layer 18 or other layer (e.g. the conversion layer 16 in the absence of the stability layer 18) to protect the photoluminescent structure 10 from physical and chemical damage arising from environmental exposure. The stability layer 18 and/or the protective layer 20 may be combined with the energy conversion layer 16 through sequential coating or printing of each layer, sequential lamination or embossing, or any other suitable means.

Additional information regarding the construction of photoluminescent structures is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Nov. 8, 2011, the entire disclosure of which is incorporated herein by reference. For additional information regarding fabrication and utilization of photoluminescent materials to achieve various light emissions, refer to U.S. Pat. No. 8,207,511 to Bortz et al., entitled “PHOTOLUMINESCENT FIBERS, COMPOSITIONS AND FABRICS MADE THEREFROM,” filed Jun. 5, 2009; U.S. Pat. No. 8,247,761 to Agrawal et al., entitled “PHOTOLUMINESCENT MARKINGS WITH FUNCTIONAL OVERLAYERS,” filed Oct. 19, 2011; U.S. Pat. No. 8,519,359 B2 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Mar. 4, 2013; U.S. Pat. No. 8,664,624 B2 to Kingsley et al., entitled “ILLUMINATION DELIVERY SYSTEM FOR GENERATING SUSTAINED SECONDARY EMISSION,” filed Nov. 14, 2012; U.S. Patent Publication No. 2012/0183677 to Agrawal et al., entitled “PHOTOLUMINESCENT COMPOSITIONS, METHODS OF MANUFACTURE AND NOVEL USES,” filed Mar. 29, 2012; U.S. Patent Publication No. 2014/0065442 A1 to Kingsley et al., entitled “PHOTOLUMINESCENT OBJECTS,” filed Oct. 23, 2012; and U.S. Patent Publication No. 2014/0103258 A1 to Agrawal et al., entitled “CHROMIC LUMINESCENT COMPOSITIONS AND TEXTILES,” filed Dec. 19, 2013, all of which are hereby incorporated by reference in their entirety.

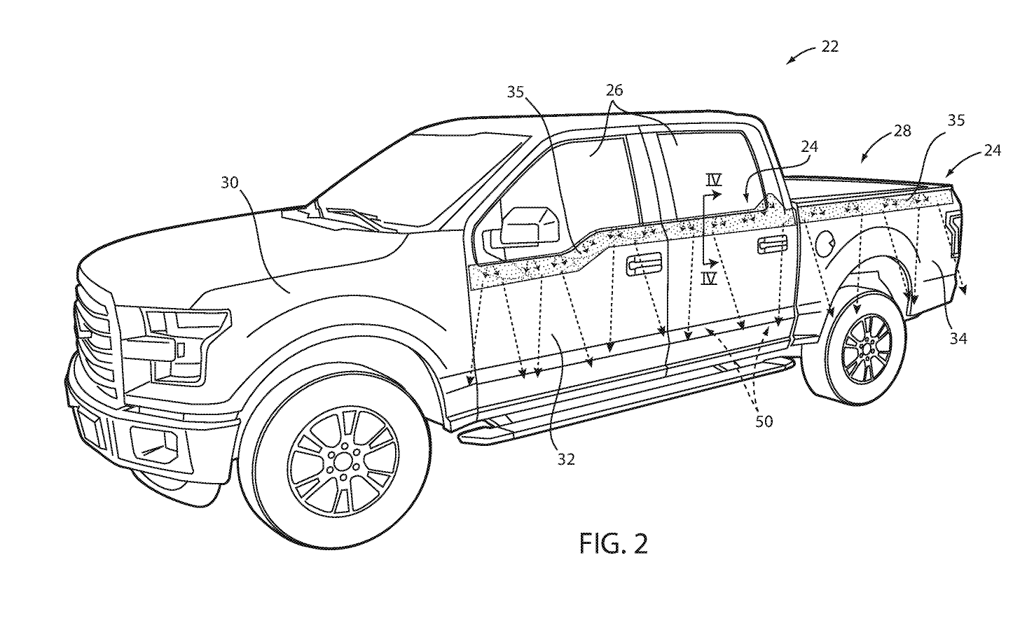

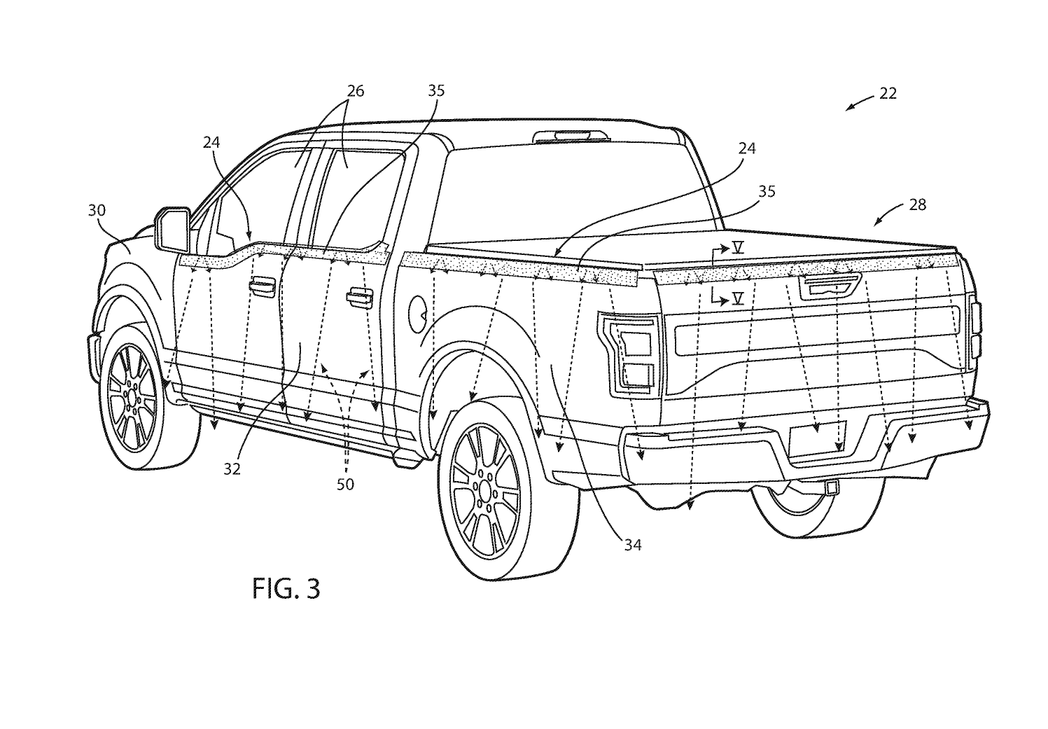

Referring to FIGS. 2 and 3, one embodiment of a vehicle 22 in the form of a pickup truck is shown having a protective molding 24. The molding may comprise an outer surface, which may correspond to a cover panel configured to seal a seam between two or more panels of the vehicle 22. The molding 24 may extend longitudinally along the belt line of the vehicle 22. According to the exemplary embodiment illustrated, the belt line may refer to a portion of the vehicle 22 extending along the sides and rear just below the side windows 26 and along an upper edge of a truck box 28. The molding 24 located along the belt line may be sectioned and coupled to the body panel of the vehicle 22, including a side panel 30, a door panel 32, and a box-side 34. As shown and described in greater detail below, the molding 24 may be configured to provide decorative and/or functional lighting. While a full-size pick-up truck is demonstrated as the vehicle 22 in FIGS. 2 and 3, it should be appreciated that the molding 24 described herein may be similarly fashioned along the belt line of various other types of vehicles including, but not limited to, coupes, sedans, trucks, sport utility, vans, convertibles, cargo vehicles, hauling vehicles, and the like. Further, it should be appreciated that protective moldings found elsewhere on the vehicle 22 may also be manufactured in accordance with the principles of the present disclosure.

Proximate the molding 24, a reflective portion 35 or a reflective strip may be disposed on each of the panels (e.g. the side panel 30, the door panel 32, and the box-side 34). The reflective portion 35 may correspond to a coating or layer of reflective material disposed on a surface of the panels. In some embodiments, the reflective portion 35 may correspond to a reflective paint configured to reflect an emission from one or more light sources disposed in the molding 24. For example, the reflective portion 35 may correspond a reflective color of paint (e.g. white, silver, light gray, and/or various light metallic paint colors. In some embodiments, the reflective portion 35 may correspond to various reflective finishes, for example metallic, chrome, mirrored, and other reflective finishes. In this configuration, the light emitted from the light sources disposed in the molding may be reflected to illuminate a region proximate the vehicle 22.

In some embodiments, the reflective portion 35 may correspond to a reflective layer applied to the panels (e.g. the side panel 30, the door panel 32, and the box-side 34) proximate the molding 24. The reflective portion 35 may comprise a coating comprising glass beads configured to reflect light impinging upon a surface formed by the reflective portion 35. In this configuration, the reflective portion 35 may be operable to reflect an output emission 50 such that the output emission is dispersed and illuminates a region proximate the vehicle 22.

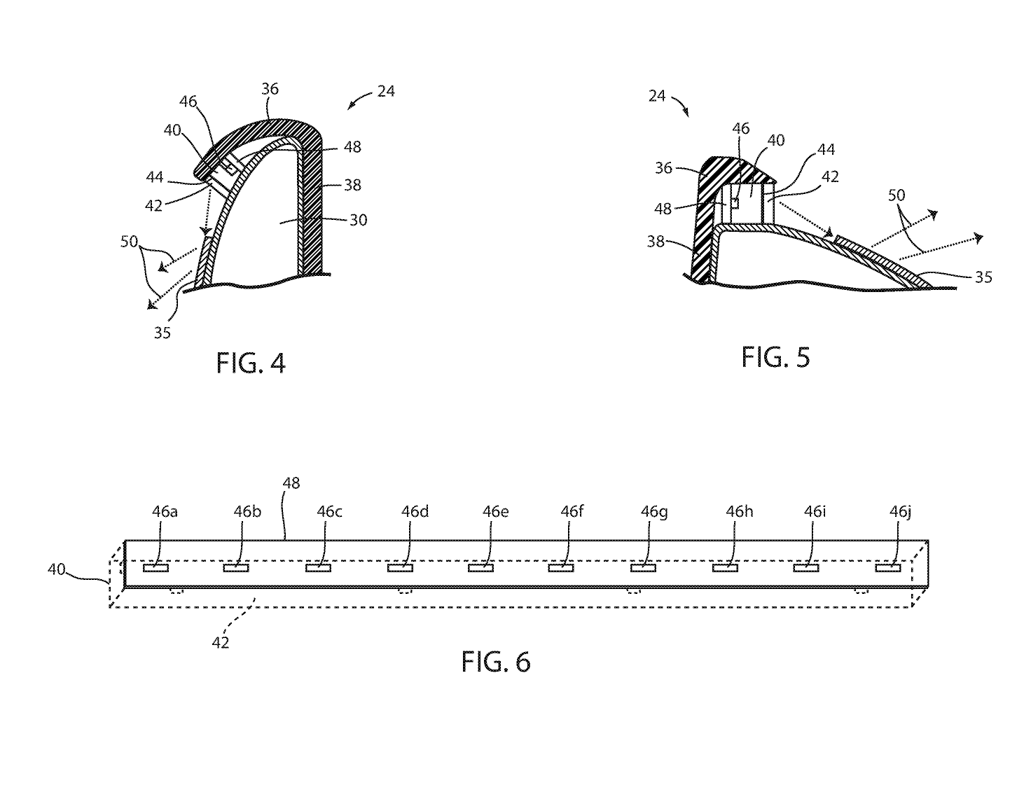

Referring to FIGS. 4 and 5, a cross sectional view of the molding 24 is shown according to one embodiment. The molding 24 includes a cover panel member 36 mounted to a body panel (e.g., side panel 30 and box-side 34) of the vehicle 22 and a mounting member 38 that may be secured to the body panel by any conventional means. The cover panel member 36 may be constructed from a flexible, resilient material, such as an elastomer. The cover panel member 36 may include a distal end configured to engage a carrier 40 such that the carrier 40 is disposed between the cover panel member 36 and the body panel. The carrier 40 may be arranged as an optical waveguide extending substantially the length of the molding 24 and may be injection molded (e.g., two shot molded) to the molding 24. In this configuration, the carrier 40 may be integrated with the molding 24 at a relatively low cost.

The optical waveguide as described in reference to the carrier 40 may correspond to a light diffusing fiber, for example a glass or polymeric optical fiber. The optical fiber may be substantially transparent and configured to bend or flex to conform to various shapes or profiles of the molding 24 and the body panels of the vehicle 22. The optical fiber may be configured to emit the output emission 50 uniformly along a length of the carrier. In this configuration, the output emission 50 may be output uniformly from the molding 24 and reflected uniformly from the reflective portion 35 to illuminate a region proximate the vehicle 22.

The front of the carrier 40 includes an emissive portion 42 configured to luminesce in response to light excitation. The emissive portion 42 may be arranged as a strip or in segments and includes a photoluminescent structure 44 applied or otherwise arranged thereon or interspersed therein. The emissive portion 42 is oriented relative to the body panel to ensure that it can be viewed by persons located outside the vehicle 22. One or more light sources 46 are disposed inside the carrier 40 and are configured to emit light for exciting the emissive portion 42. More specifically, light emitted from the light source 46 that reaches the emissive portion 42 is converted by the photoluminescent structure 44 and re-emitted as light having a different wavelength, typically in the visible spectrum. The light source 46 may be disposed on a flexible circuit board 48 (e.g., a copper flexible circuit) that is coupled to the rear of the carrier 40. In such an arrangement, the flexible circuit board 48 may flex in conjunction with the cover panel member 36 to allow the molding 24 to be contoured to the body panel.

Though described in detail incorporating the photoluminescent structure 44, in some embodiments, the lighting system 8 may utilize various forms of light sources and may not incorporate the photoluminescent structure 44. For example, the light sources 46 may correspond to various forms of light sources. The light sources 46 may correspond to halogen lighting, fluorescent lighting, light emitting diodes (LEDs), red-green-blue (RGB) LEDs, organic LEDs (OLEDs), polymer LEDs (PLEDs), solid state lighting or any other form of lighting configured to generate the output emission 50.

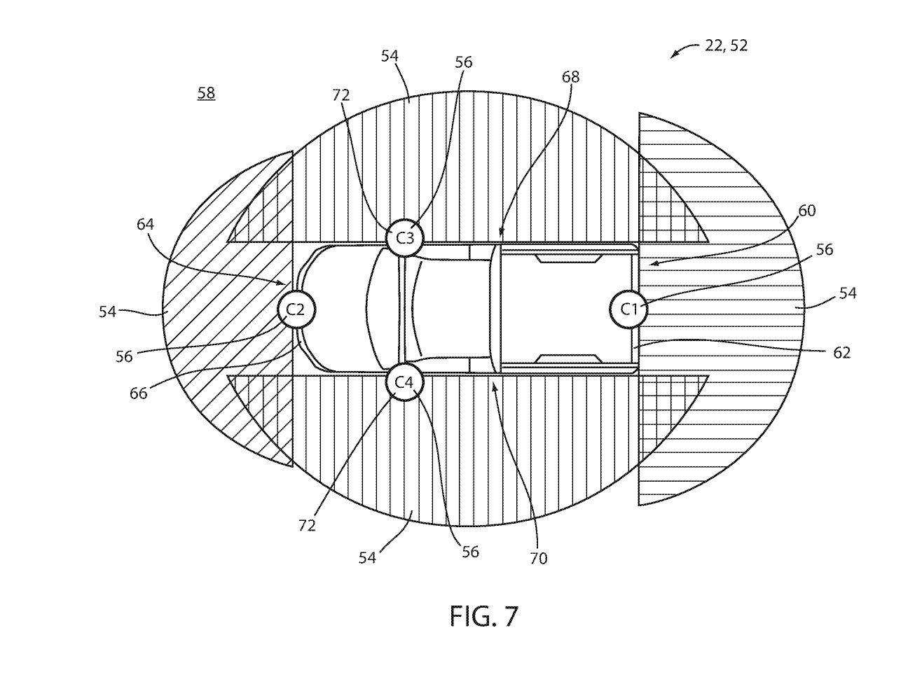

In an exemplary embodiment, the one or more light sources 46 may be configured to be emitted from the emissive portion 42 such that an output emission 50 is directed toward the reflective portion 35 or a reflective strip on the panels proximate the emissive portion 42. The output emission 50 may be received and reflected from the reflective portion 35 and dispersed outward to illuminate a region proximate the vehicle 22. The output emission 50 may be selectively activated to illuminate the region proximate the vehicle 22 in response to an activation of a camera to monitor or image the region proximate the vehicle 22. As such, the illumination from the output emission may be activated by the controller to provide for improved lighting for one or more camera or driver assist systems of the vehicle. Further details of an exemplary camera system are discussed in reference to FIG. 7.

Referring to FIG. 6, a plurality of light sources 46a-j are disposed on the flexible circuit board 48. The flexible circuit board 48 is snapably engaged or otherwise secured to the carrier 40. The light sources 46a-j may be selectively activated by a controller in communication with a vehicle power supply (e.g., a vehicle battery) and are each configured to emit non-focused light toward a section of the emissive portion 42 located in front thereof. The light sources 46a-j may be spaced such that light is distributed across the substantial entirety of the emissive portion 42 when the light sources 46a-j are simultaneously activated such that uniform excitation is provided to the emissive portion 42. Additionally, the non-exposed walls of the carrier 40 and the surface of the flexible circuit board 48 facing the emissive portion 42 may be configured to internally reflect light within the carrier 40, thereby optimizing excitation, and in turn, the perceived luminescence of the emissive portion 42.

In operation, each light source 46a-j may be controlled by the controller, which may further be in communication with a control module of the vehicle 22. The controller may selectively activate the light sources 46a-j to illuminate a region proximate the vehicle 22. The region may correspond to a scene captured by one or more cameras configured to monitor the region proximate the vehicle 22. In this configuration, the controller may selectively activate the light sources 46a-j to illuminate the reflective portion 35 or a reflective strip disposed on the panels.

According to one embodiment, the light sources 46a-j may be activated at varying intensity (e.g., by pulse-width modulation or direct current control) to dictate the intensity of brightness in which the emissive portion 42 luminesces. For example, the light sources 46a-j may be activated in unison to emit light at a lower intensity when the vehicle 22 is idle or in drive and at a higher intensity when the vehicle brakes are applied. The light sources 46a-j may continue to emit light at the higher intensity so long as the brakes are applied, resulting in the emissive portion 42 luminescing at a higher brightness relative to when the light sources 46a-j are activated at the lower intensity. The carrier 40 and flexible circuit board 48 ensemble may be coupled to a molding 24 located to the rear of the vehicle 22, such as that shown in FIG. 2. Further, the light sources 46a-j may be configured as blue LEDs and the emissive portion 42 may be configured to luminesce in a red color in response to excitation by blue light. In this manner, the molding 24 may function as a brake light consistent with pre-existing brake lights such as taillights and center high mount stop lamps (CHMSL).

In some embodiments, the carrier 40 and flexible circuit board 48 may be coupled to an exterior door molding. When the door is opened, the light sources 46a-j may be simultaneously activated such that the emissive portion 42 luminesces (e.g., in a white color), thereby making the door more visible to oncoming vehicles.

According to an exemplary embodiment, the light sources 46a-j may be activated in unison to emit light intermittently such that the emissive portion 42 luminesces in a blinking pattern. Thus, if the carrier 40 and flexible circuit board 48 ensemble is provided in moldings 24 located on the sides of the vehicle 22, the respective moldings 24 may function as turn signals. That is, the light sources 46a-j associated with the molding located on the left side of the vehicle 22 may be activated when a vehicle operator moves a turn signal lever to indicate a left turn such that the emissive portion 42 on the left side of the vehicle 22 luminesces in a similar blinking pattern as that of the left headlight and/taillight. Likewise, the light sources 46a-j associated with the molding 24 on the right side of the vehicle 22 may be activated when the vehicle operator moves the turn signal lever to indicate a right turn such that the emissive portion 42 on the right of the vehicle 22 luminesces in a similar blinking pattern as that of the right headlight and/or taillight. Additionally, the light sources 46a-j on each side of the vehicle 22 may be activated together when the vehicle operator activates a hazard switch such that the emissive portions 42 on each side of the vehicle 22 luminesce in a similar blinking pattern as that of the hazard lights. With respect to the presently described embodiment, the emissive portion 42 may be configured to luminesce in a color that matches the beam color of the headlights of the vehicle 22, such as amber or white. Though described as being exposed to provide for visible illumination of the emissive portion 42, the emissive portions may also be hidden such that the origin of the output emission is less apparent.

According to yet another embodiment, the light sources 46a-j may be activated to produce a variety of decorative effects. For example, the light sources 46a-j may be activated in succession, beginning with light source 46a, followed by light source 46b, light source 46c, and so on, and ending with light source 46j, thereby causing the emissive portion 42 to gradually luminesce in its entirety. Once light source 46j is activated, the light sources 46a-j may be deactivated to attenuate or eliminate altogether the luminescence of the emissive portion 42. Thereafter, the actuation sequence outlined above may be repeated once more. Additionally or alternatively, each of the light sources 46a-j may be activated and deactivated in turn to produce the impression of a moving light across the emissive portion 42. Additionally or alternatively still, a portion of the light sources 46a-j may be configured to emit light at a first wavelength and another portion of the light sources 46a-j may be configured to emit light at a second wavelength that is different than the first wavelength. In this manner, the emissive portion 42 or sections thereof may be configured to luminesce in a first color when only the first portion of the light sources 46a-j are activated and a second color when only the second portion of the light sources 46a-j are activated. When both the first and second portions of the light sources 46a-j are activated together, the emissive portion 42 luminesces in a third color that is made up of a light mixture of the first and second colors. Since the current draw to the light sources 46a-j is typically low, the light sources 46a-j may be activated or remain activated to produce luminescent lighting even when the vehicle 22 is turned OFF. The light sources 46a-j may be deactivated once a certain time period has lapsed or may shut off automatically if the vehicle power supply becomes low.

Referring now to FIG. 7, an exemplary embodiment of a camera system 52 is shown. The camera system 52 may be implemented with the vehicle 22 to capture image data for display on one or more display screens of the vehicle. In some embodiments, the image data may correspond to a region proximate the vehicle 22 including at least one field of view 54 of one or more imaging devices 56 or cameras. The one or more imaging devices 56 may correspond to a plurality of imaging devices C1-C4. Each of the imaging devices may have a field of view focusing on an environment 58 proximate the vehicle 22. In the various implementations discussed herein, the imaging devices C1-C4 may be implemented to provide views of the environment 58 proximate the vehicle 22 that may be displayed on a display screen or any form of display device some of which may be visible to an operator of the vehicle 22.

The imaging devices C1-C4 may be arranged in various locations such that each of the fields of view 54 of the imaging devices C1-C4 is configured to capture a significantly different portion of the surrounding environment 58. Each of the imaging devices C1-C4 may comprise any form of device configured to capture image data, for example Charge Coupled Device (CCD) and Complementary Metal Oxide Semiconductor (CMOS) image sensors. Though four imaging devices are discussed in reference to the present implementation, the number of imaging devices may vary based on the particular operating specifications of the particular imaging devices implemented and the proportions and/or exterior profiles of a particular vehicle and trailer. For example, a large vehicle may require additional imaging devices to capture image data corresponding to a larger surrounding environment. The imaging devices may also vary in viewing angle and range of a field of view corresponding to a particular vehicle.

The imaging devices C1, C2, C3, and C4 are disposed on the vehicle 22 and oriented such that each field of view 54 of the imaging devices is directed toward a substantially different region of the environment 58. A first imaging device C1 is disposed centrally on a rear facing portion 60 of the vehicle 22 proximate a tailgate 62 or similar area of the vehicle 22. In some embodiments, the imaging device C1 may be disposed proximate a rear-bumper. A second imaging device C2 is disposed centrally on a front facing portion 64 of the vehicle 22 proximate a front grill portion 66.

The imaging devices C3 and C4 are disposed on a passenger's side 68 and a driver's side 70 of the vehicle 22 respectively and are configured to capture image data corresponding to the environment 58 to the sides of the vehicle 22. In some implementations, the third imaging device C3 and the fourth imaging device C4 may be disposed in side mirrors 72 of the vehicle 22. The imaging devices C3 and C4, in combination with imaging devices C1 and C2, may be configured to capture image data corresponding to approximately the entire environment 58 proximate the vehicle 22. In some embodiments, the imaging devices C1-C4 may be in communication with a controller configured to selectively activate the imaging devices C1-C4. In an exemplary embodiment, the controller may selectively activate all or a portion of the light sources 46 disposed in the molding 24 to illuminate one or more of the fields of view 54. The controller may further be configured to selectively activate specific portions of the light sources 46 corresponding to one or more of fields of view being recorded by the imaging devices C1-C4.

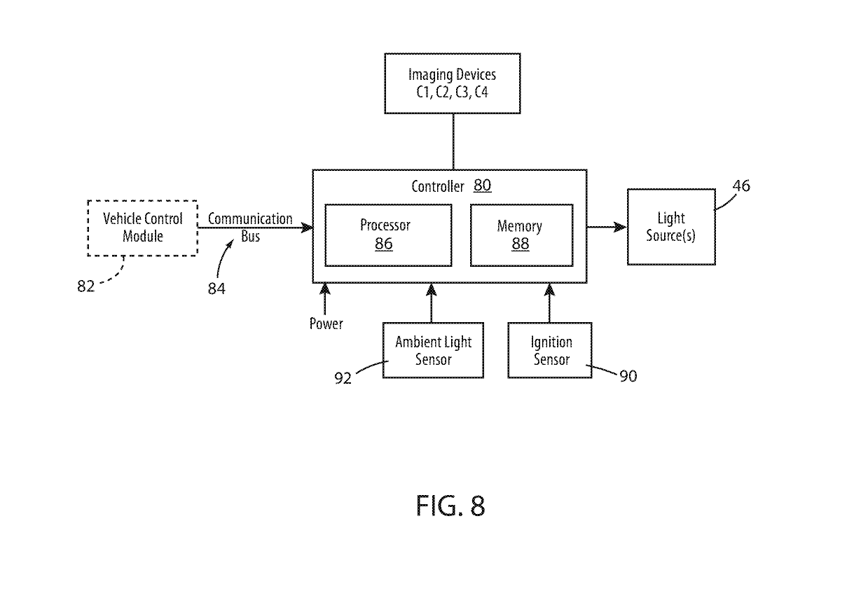

Referring now to FIG. 8, a block diagram of a lighting controller or a controller 80, which may be configured to control each of the light sources 46, is shown. The controller 80 may further be in communication with each of the imaging devices C1-C4. In this configuration, the controller 80 may be operable to selectively activate a portion of the light sources corresponding to a field of view 54 of each of the imaging devices C1-C4. For example, the controller 80 may identify a dark ambient lighting condition and activate the second imaging device C2 and the third imaging device C3. In response to the activation of the imaging devices C2 and C3 and the dark ambient light condition, the controller may selectively activate the light sources 46 corresponding to the fields of view of the imaging devices C2 and C3. In this configuration, the disclosure may provide for improved imaging of the region proximate the vehicle in dark ambient conditions.

The controller 80 may be in communication with a vehicle control module 82 via a communication bus 84 of the vehicle. The communication bus 84 may be configured to deliver signals to the controller 80 identifying various states of the vehicle. For example, the communication bus 84 may be configured to communicate an operating condition of the vehicle (e.g. the ignition is active), an ambient light level, a seat occupancy, a door ajar signal, or any other information or control signals that may be communicated via the communication bus 84. In this way, the controller 80 may selectively activate the light sources 46 in response to one or more conditions communicated by the vehicle control module 82.

The controller 80 may include a processor 86 comprising one or more circuits configured to receive the signals from the communication bus 84 and output signals to control the light sources (e.g. 42 and 44) discussed herein. The processor 86 may be in communication with a memory 88 configured to store instructions to control the activation of the light sources 46. The controller 80 may further be in communication with an ignition sensor 90, an ambient light sensor 92, and various other sensors of the vehicle 22. Each of the imaging devices C1-C4 may be in communication with the controller 80 via a communication link and/or via the communication bus 84. In this configuration, the controller 80 may be configured to selectively activate the imaging devices C1-C4 in response to a variety of vehicle conditions that may be communicated via the communication bus 84.

The ambient light sensor 92 may be operable to communicate a light condition, for example a level brightness or intensity of the ambient light proximate the vehicle 22. In response to the level of the ambient light, the controller 80 may be configured to adjust a light intensity output from the light sources 46. Additionally, the controller 80 may be configured to selectively activate all or a portion of the light sources 46 corresponding to one or more fields of view that are being recorded by the imaging devices C1-C4.

Referring to FIGS. 2, 3, and 7, the lighting system 8 may provide for various functions, which may be provided by the controller 80. In some embodiments, the controller 80 may identify when the camera system 52 is active and illuminate a region proximate the vehicle 22 corresponding to one or more of the image devices C1-C4. When all of the imaging devices C1-C4 are active, the controller 80 may activate the lighting system 8 to illuminate a region corresponding to the 360-degree field of view of the imaging devices C1-C4. The controller 80 may activate the lighting system 8 in providing for improved visibility and recognition for autonomous or conventional operation of the vehicle 22.

In some embodiments, the controller 80 may be in communication with a gear selection sensor, a speed sensor, positional or GPS sensor, etc. via the communication bus 84 to activate the lighting system 8 during various states of operation of the vehicle 22. For example, the controller 80 may activate the lighting system 8 to illuminate under the following conditions: for a predetermined time duration after motion of the vehicle 22 begins, until a speed threshold is exceeded, after the vehicle 22 has traveled a predetermined distance, in response to an activation request of the lighting system 8 from one or more user interfaces in communication with the controller 80.

The controller 80 may be in communication with a load sensor, which may be configured to identify if a spring or suspension height is below a minimum height threshold. The minimum height threshold may identify an overloaded condition of the vehicle 22. In response to the load sensor identifying the overloaded condition, the controller 80 may activate the lighting system 8 affixed to the truck box 28 to illuminate in red. In this way the lighting system may alert the operator of the overloaded condition.

The controller 80 may also activate the lighting system 8 to flash in red, white, or any color in response to the following conditions: upon sensing an attempt lock the vehicle 22 when the vehicle is occupied (e.g. as detected by a seat occupancy sensor); an attempt lock the vehicle 22 when a window, moonroof, or closure is ajar; and an attempt to exit and/or lock the vehicle 22 when the engine is running and the vehicle 22 is not occupied.

In some embodiments, the controller 80 may also activate one or more sections of the lighting system 8 to flash red in response to a remote start request received by the vehicle 22. The controller 80 may deactivate the flashing upon an approach of an operator of the vehicle 22 or a corresponding approach of a key fob configured to be detected within a proximity of the vehicle 22. Additionally, the controller 80 may selectively activate the lighting system 8 in response to receiving a remote lock or unlock request. In an exemplary embodiment, the controller 80 may activate the lighting system 8 to emit a green flashing light in response to an unlock request and a red flashing light in response to a locking request. As discussed previously herein, the illumination of the lighting system 8 in various colors may be provided by a variety of lighting technologies, for example the use of RGB LEDs for the light sources 46.

The disclosure describes a vehicle lighting system 8 that may employ one or more photoluminescent structures configured to convert light received from an associated light source and re-emit the light at a different wavelength. The vehicle lighting system 8 may be utilized to illuminate an area proximate a vehicle. The illumination may be controlled to provide for improved lighting for one or more camera or driver assist systems of the vehicle. In this way, the lighting system 8 provides for improved imaging for the camera system in dark ambient lighting conditions.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present disclosure, and further it is to be understood that such concepts are intended to be covered by the following claims unless these claims by their language expressly state otherwise.

1. A lighting apparatus for a vehicle, comprising:
a cover portion mounted to a body panel and forming an opening extending along a perimeter of the body panel;
at least one light source disposed within the opening and configured to emit light outward through the opening; and
a reflective portion disposed proximate the opening, wherein the light is projected from the reflective portion to illuminate a region proximate the vehicle.

2. The lighting apparatus according to claim 1, wherein the cover portion corresponds to a molding portion.

3. The lighting apparatus according to claim 2, wherein the molding portion comprises a carrier disposed between the cover portion and the body panel, the carrier having an exposed portion configured to luminesce in response to the light from the light source.

4. The lighting apparatus according to claim 2, wherein the molding portion extends substantially around a perimeter of the vehicle illuminating the region.

5. The lighting apparatus according to claim 1, wherein the reflective portion corresponds to a reflective strip extending substantially coextensive to the cover portion.

6. The lighting apparatus according to claim 1, wherein the reflective portion corresponds to a layer of reflective material disposed on a surface of the panel.

7. The lighting apparatus according to claim 6, wherein the reflective material corresponds to a reflective paint disposed on the panel configured to reflect the light to illuminate the region proximate the vehicle.

8. A monitoring system for a vehicle, comprising:
a lighting apparatus comprising:
a cover portion proximate a perimeter of a body panel; and
a light source concealed by the cover portion and configured to output an emission; and
an imaging device configured to capture a field of view; and
a controller in communication with the imaging device and the light source, wherein the controller is configured to:
receive image data from the imaging device; and
control the light source to illuminate a region proximate the vehicle with the emission, the region corresponding to the field of view.

9. The monitoring system according to claim 8, wherein the imaging device corresponds to a plurality of imaging devices configured to capture the image data corresponding to a panoramic scene extending at least 180 degrees around the vehicle.

10. The monitoring system according to claim 9, wherein the light source corresponds to a plurality of light sources extending around a belt-line of the vehicle.

11. The monitoring system according to claim 10, wherein the controller is configured to selectively activate a portion of the light sources corresponding to one or more of the fields of view of the imaging devices.

12. The monitoring system according to claim 8, further comprising a reflective portion disposed on the body panel proximate the cover portion.

13. The monitoring system according to claim 12, wherein the emission is projected from the reflective portion to illuminate the region proximate the vehicle.

14. The monitoring system according to claim 8, wherein the cover portion forms an opening extending along the perimeter of the body panel and the light source is configured to output the emission through the opening.

15. The monitoring system according to claim 8, further comprising
a carrier disposed between the cover portion and the body panel, the carrier having an exposed portion configured to luminesce in response to the emission from the light source.

16. A lighting system of a vehicle configured to illuminate a field of view of an imaging system comprising:
a cover portion at least partially covering a seam of a body panel of the vehicle;
a carrier disposed between the cover portion and the body panel, the carrier having an exposed portion configured to luminesce in response to a light excitation; and
at least one light source configured to emit light for exciting the exposed portion.

17. The molding according to claim 16, wherein the carrier is arranged as an optical waveguide and is injection molded to the molding.

18. The molding according to claim 16, wherein the at least one light source is disposed on a flex circuit snapably engaged to the carrier.

19. The molding according to claim 16, wherein the body panel corresponds to a plurality of body panels comprising at least a side panel and a rear panel and the molding extends along the plurality of body panels.

20. The molding according to claim 16, wherein the at least one light source comprises a plurality of light source configured to selectively illuminate a portion of a region proximate to and extending around the vehicle.
